(19) United States
(12) Patent Application Publication
(10) Pub. No.: US 2011/0185890 A1
(43) Pub. Date: Aug. 4, 2011

(54) SEALING MEMBER FOR MASTER CYLINDER AND MASTER CYLINDER HAVING THE SAME

(75) Inventor: Dong Gu KANG, Seoul (KR)

(73) Assignee: MANDO CORPORATION

(21) Appl. No.: 12/950,315

(22) Filed: Nov. 19, 2010

(30) Foreign Application Priority Data
Nov. 20, 2009 (KR) 10-2009-0112369

(51) Int. Cl. F16J 15/18; F16J 15/34

(52) U.S. Cl. 92/165 R; 277/402

(57) ABSTRACT

Disclosed is a sealing member for a master cylinder and the master cylinder having the same, capable of shortening the delay in the release operation of the hill start assist control system. The sealing member includes an outer blade making contact with the cylinder body and an inner blade making contact with the outer surface of the piston. The inner blade includes a circumferential fluid path extending in a circumferential direction of the inner blade and a plurality of axial fluid paths connected to the circumferential fluid path.

This application claims the benefit of Korean Patent Application No. 10-2009-0112369 filed on Nov. 20, 2009, in the Korean Intellectual Property Office, the disclosure of which is incorporated herein by reference.

### BACKGROUND

1. Field

The disclosure relates to a sealing member for a master cylinder and the master cylinder having the same. More particularly, the disclosure relates to a sealing member for a master cylinder, capable of shortening the delay in the release operation of the hill start assist control system, and the master cylinder having the same.

2. Description of the Related Art

In general, a master cylinder generates hydraulic pressure in a hydraulic brake system. FIG. 1 shows an example of a normal tandem type master cylinder and an oil tank.

As shown In FIG. 1, the master cylinder includes first and second pistons 3 and 4 installed in a bore 2 of a cylinder body 1. The first and second pistons 3 and 4 have through holes 9 to allow oil to be introduced into first and second liquid pressure chambers 7 and 8 through first and second oil inlet ports 6 communicated with an oil tank 5. The through holes 9 are shifted forward beyond sealing members 11 as the first and second pistons 3 and 4 moves forward, thereby pressurizing the first and second liquid pressure chambers 7 and 8. In contrast, if the first and second pistons 3 and 4 move back, the through holes 9 are shifted rearward of the sealing members 11, so that the through holes 9 are communicated with the first and second oil inlet ports 6. Thus, oil in the first and second liquid pressure chambers 7 and 8 may return to the oil tank 5, thereby releasing the brake pressure.

As shown in FIG. 2A, the sealing member 11 is prepared in the form of a ring and installed in a receiving groove 1a of the cylinder body 1. The sealing member 11 includes an inner blade 11a making contact with an outer surface of the second piston 4 and an outer blade 11b making contact with an inner surface of the receiving groove 1a. The sealing member 11 has a sectional shape in the form of a cup, so the sealing member 11 is called a cup seal.

As shown in FIG. 2B, when the second piston 4 moves forward, pressure of the second liquid pressure chamber 8 is applied to an inner surface of the sealing member 11, so the inner and outer blades 11a and 11b may closely adhere to the outer surface of the second piston 4 and the inner surface of the receiving groove 1a, thereby shutting off the oil flow. Thus, the pressure of the second liquid chamber 8 may be increased. As the pressure of the second liquid chamber 8 is increased, the deformation degree of the inner and outer blades 11a and 11b is also increased, so the adhering force of the inner and outer blades 11a and 11b is increased.

Meanwhile, recently, a hill start assist control (HAC) system has been installed in a vehicle to improve convenience of a driver by preventing the roll-back of the vehicle through the brake control when the driver starts to drive the vehicle on a slope road.

However, according to the related art, back pressure is introduced into the master cylinder within a short period of time upon the release operation of the HAC system, so the sealing members may be excessively deformed by the back pressure. If the sealing members are excessively deformed, the through holes are sealed by the sealing members, causing the delay of the release operation of the HAC system, that is, the brake release operation may be delayed.

### SUMMARY

Accordingly, it is an aspect of the disclosure to provide a sealing member for a master cylinder, which can be prevented from being deformed upon the release operation of the HAC system, and the master cylinder having the same.

Additional aspects and/or advantages of the disclosure will be set forth in part in the description which follows and, in part, will be apparent from the description, or may be learned by practice of the disclosure.

The foregoing and/or other aspects of the disclosure are achieved by providing a sealing member for a master cylinder installed between an inner surface of a cylinder body and an outer surface of a piston. The sealing member includes an outer blade making contact with the cylinder body and an inner blade making contact with the outer surface of the piston. The inner blade includes a circumferential fluid path extending in a circumferential direction of the inner blade and a plurality of axial fluid paths connected to the circumferential fluid path.

According to the disclosure, the circumferential fluid path and the axial fluid paths are formed on a surface of the inner blade facing the outer surface of the piston.

According to the disclosure, the axial fluid paths are formed on an inner surface of the inner blade while being spaced part from each other.

According to another aspect, there is provided a master cylinder including a cylinder body defining a liquid pressure chamber, at least one piston movable back and forth in the cylinder body and formed with a through hole for receiving or exhausting oil, and at least one sealing member installed between an inner surface of the cylinder body and an outer surface of the piston. The sealing member includes an outer blade making contact with the cylinder body; and an inner blade making contact with the outer surface of the piston. The inner blade includes a circumferential fluid path extending in a circumferential direction of the inner blade and a plurality of axial fluid paths connected to the circumferential fluid path.

According to the disclosure, the circumferential fluid path and the axial fluid paths are formed on a surface of the inner blade facing the outer surface of the piston.

According to the disclosure, the axial fluid paths are formed on an inner surface of the inner blade while being spaced part from each other.

As described above, according to the master cylinder of the disclosure, the circumferential fluid path and a plurality of axial fluid paths connected to the circumferential fluid path are formed in the inner blade, so that the sealing member can be prevented from being excessively deformed upon the release operation of the HAC system.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a sectional view showing a master cylinder according to the related art;

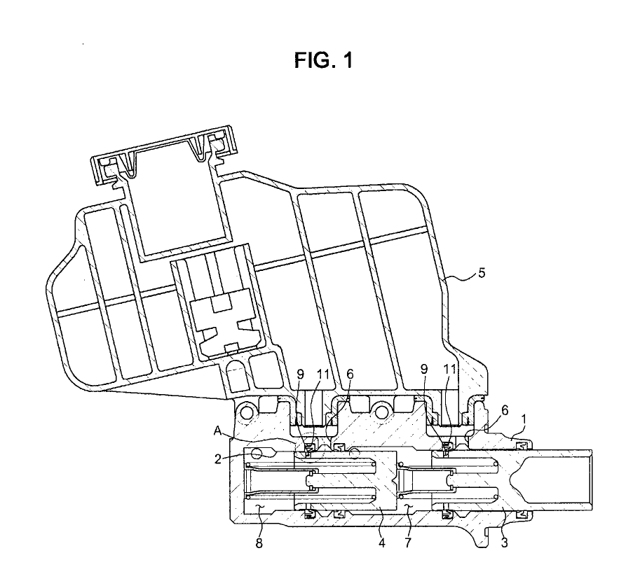

FIG. 2A is a detailed sectional view of “A” shown in FIG. 1 for illustrating a sealing member;

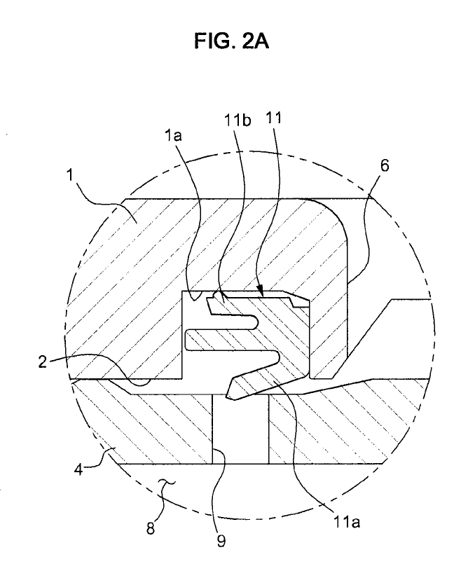

FIG. 2B is a detailed sectional view of “A” shown in FIG. 1 for illustrating a sealing member when a piston moves forward;

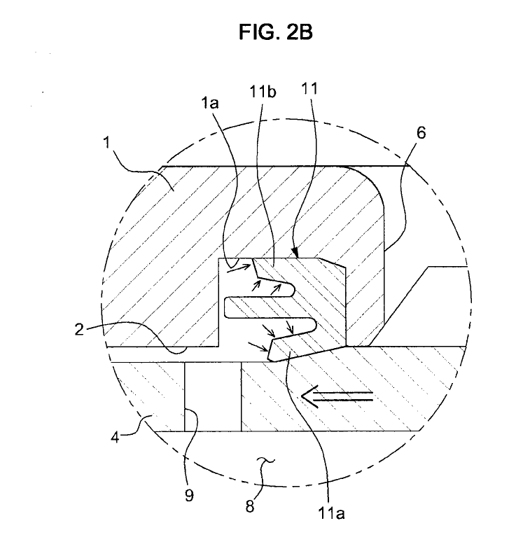

FIG. 3 is a sectional view showing a master cylinder according to the disclosure;

FIG. 4 is a detailed sectional view of “B” shown in FIG. 3 for illustrating a sealing member; and

FIG. 5 is a perspective view showing a sealing member for a master cylinder according to the disclosure.

### DETAILED DESCRIPTION OF THE EXEMPLARY EMBODIMENTS

Reference will now be made in detail to the embodiments of the disclosure, examples of which are illustrated in the accompanying drawings, wherein like reference numerals refer to the like elements. The embodiments are described below to explain the disclosure by referring to the figures.

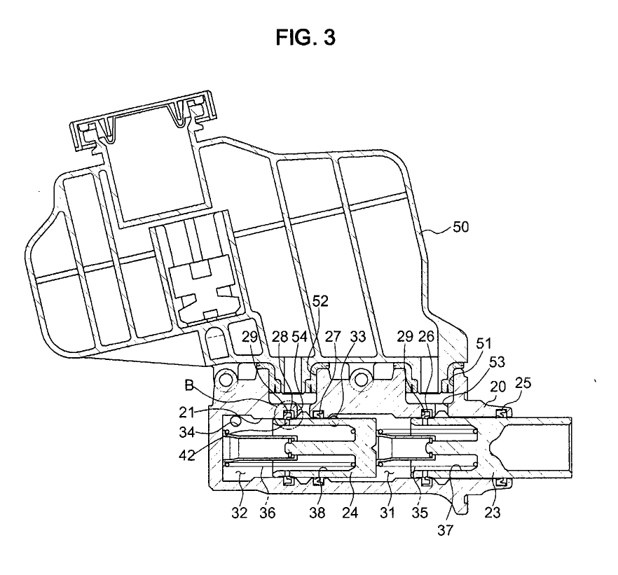

FIG. 3 is a sectional view showing a master cylinder according to the disclosure. As shown in FIG. 3, the master cylinder includes a cylinder body 20 formed therein with a bore 21, and first and second pistons 23 and 24 movable back and forth in the bore 21 of the cylinder body 20.

First and second sealing members 25 and 26 are installed between an inner surface of the bore 21 and an outer surface of the first piston 23, and third and fourth sealing members 27 and 28 are installed between the inner surface of the bore 21 and an outer surface of the second piston 24, respectively.

The sealing members 25 to 28 are accommodated in receiving grooves 29 formed in the bore 21 in such a manner that the sealing members 25 to 28 can be fixedly maintained when the pistons 23 and 24 move back and forth. Due to the above configuration, the internal space of the bore 21 is divided into a first liquid pressure chamber 31 defined between the first and second pistons 23 and 24 and a second liquid pressure chamber 32 defined between the second piston 24 and an inner surface of a terminal end of the bore 21.

A first oil exhaust hole 33 is formed in the cylinder body 20 corresponding to the first liquid pressure chamber 31 and a second oil exhaust hole 34 is formed in the cylinder body 20 corresponding to the second liquid pressure chamber 32 such that oil can be exhausted from the first and second liquid pressure chambers 31 and 32 when the first and second liquid pressure chambers 31 and 32 are pressurized by the first and second pistons 23 and 24.

Therefore, as the first piston moves forward, the first piston 23 presses the first liquid pressure chamber 31 and the second piston 24 is pressed by the pressure of the first liquid pressure chamber 31, so that the second piston 24 presses the second liquid pressure chamber 32. Thus, the oil contained in the first and second liquid pressure chambers 31 and 32 is exhausted through the first and second oil discharge holes 33 and 34 and supplied to a wheel cylinder (not shown) provided at a wheel.

A first return spring 35 is installed in the first liquid pressure chamber 31 to return the first piston 23 to its initial position after the braking operation has been completed. In addition, a second return spring 36 is installed in the second liquid pressure chamber 32 to return the second piston 24 to its initial position. Further, spring receiving grooves 37 and 38 are formed in the first and second pistons 23 and 24 to receive the first and second return springs 35 and 36 therein, respectively.

First and second oil inlet ports 51 and 52 connected to an oil tank 50 are formed at an upper portion of the cylinder body 20. The first and second oil inlet ports 51 and 52 are communicated with the first and second liquid pressure chambers 31 and 32 through first and second oil inlet holes 53 and 54, respectively.

To the end, the first oil inlet hole 53 is formed between first and second sealing members 25 and 26 and the second oil inlet hole 54 is formed between the third and fourth sealing members 27 and 28. In addition, the first and second pistons 23 and 24 are formed with a plurality of through holes 41 and 42 such that oil introduced through the first and second oil inlet holes 53 and 54 can be transferred to the first and second liquid pressure chambers 31 and 32.

The second and fourth sealing members 26 and 28 are prepared in the form of rings. These sealing members have the same structures, so the following description will be made with reference to the fourth sealing member 28.

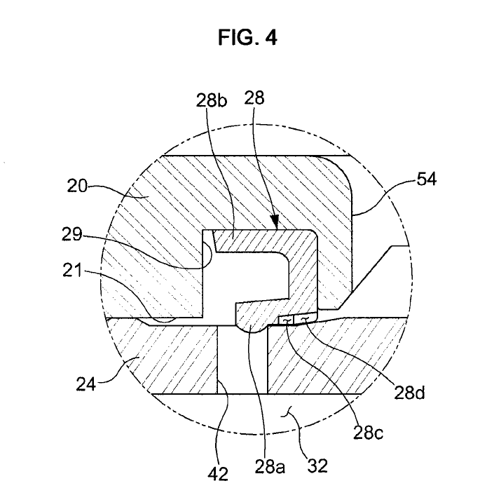

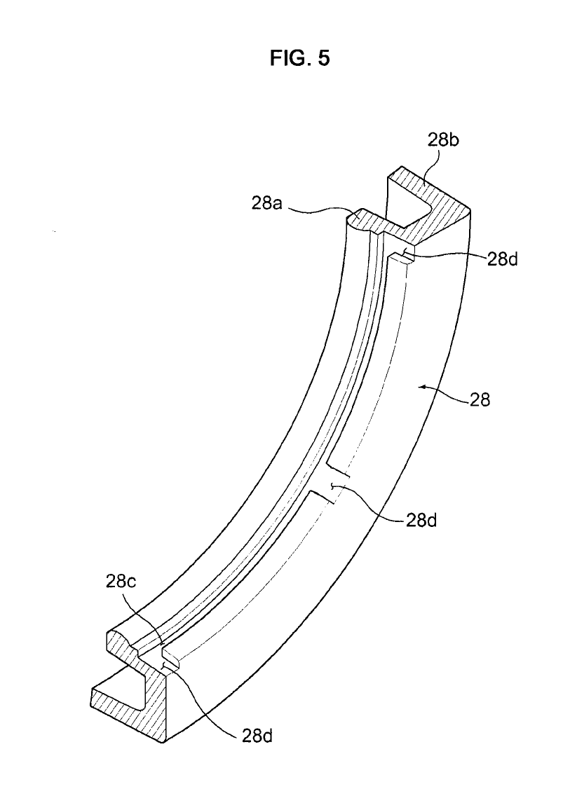

As shown in FIGS. 4 and 5, the fourth sealing member 28 includes an inner blade 28a making contact with an outer surface of the second piston 24 and an outer blade 28b making contact with an inner surface of the receiving groove 29. The fourth sealing member 28 has a sectional shape in the form of a cup.

The inner blade 28a has a front end, which makes contact with the outer surface of the second piston 24 to close the fluid path formed at the outer surface of the second piston 24.

In addition, the inner blade 28a has an oil path, which is formed at a surface of the inner blade 28a in opposition to the outer surface of the second piston 24. The oil path may include a circumferential fluid path 28c extending in the circumferential direction along the inner blade 28a and a plurality of axial fluid paths 28d connected to the circumferential fluid path and extending in the axial direction.

As shown in FIGS. 4 and 5, the circumferential fluid path 28c extends in the circumferential direction of the inner blade 28a and is formed on the surface of the inner blade 28a, which is opposite to the outer surface of the second piston 24.

The axial fluid paths 28d are connected to the circumferential fluid path 28c and formed on the inner surface of the inner blade 28a while being spaced apart from each other. Preferably, three to seven axial fluid paths 28d are provided. That is, the axial fluid paths 28d are formed on the inner surface of the inner blade 28a while being spaced apart from each other in the circumferential direction of the inner blade 28a.

Meanwhile, according to the embodiment of the present invention, the hill start assist control (HAC) system can be installed in the vehicle to prevent the roll-back of the vehicle through the brake control when the driver starts to drive the vehicle on a slope road. In this case, the back pressure is introduced into the master cylinder within a short period of time upon the release operation of the HAC system.

If the back pressure is introduced into the master cylinder within a short period of time, the sealing members may be excessively deformed by the back pressure, so the through holes may be sealed by the sealing members. According to the present invention, the back pressure introduced into the master cylinder upon the release operation of the HAC system is lowered to the level of atmospheric pressure through the circumferential fluid path 28c and the axial fluid paths 28d connected to the circumferential fluid path 28c of the sealing members, so that the sealing members can be prevented from being excessively deformed.

Since the sealing members can be prevented from being excessively deformed, the delay of the release operation of the HAC system, that is, the delay of the brake release operation can be prevented.

In addition, according to the embodiment of the present invention, since the circumferential fluid path and the axial fluid paths are formed in the inner blade of the sealing member, the contact area of the sealing member with respect to the outer surface of the piston can be increased, so that the noise caused by the narrow contact area can be reduced and the sealing member can stably make contact with the piston.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A sealing member for a master cylinder installed between an inner surface of a cylinder body and an outer surface of a piston, the sealing member comprising:
an outer blade making contact with the cylinder body; and
an inner blade making contact with the outer surface of the piston,
wherein the inner blade includes a circumferential fluid path extending in a circumferential direction of the inner blade and a plurality of axial fluid paths connected to the circumferential fluid path.

2. The sealing member of claim 1, wherein the circumferential fluid path and the axial fluid paths are formed on a surface of the inner blade facing the outer surface of the piston.

3. The sealing member of claim 1, wherein the axial fluid paths are formed on an inner surface of the inner blade while being spaced part from each other.

4. A master cylinder comprising:
a cylinder body defining a liquid pressure chamber;
at least one piston movable back and forth in the cylinder body and formed with a through hole for receiving or exhausting oil; and
at least one sealing member installed between an inner surface of the cylinder body and an outer surface of the piston,
wherein the sealing member comprises:
an outer blade making contact with the cylinder body; and
an inner blade making contact with the outer surface of the piston, and
wherein the inner blade includes a circumferential fluid path extending in a circumferential direction of the inner blade and a plurality of axial fluid paths connected to the circumferential fluid path.

5. The master cylinder of claim 4, wherein the circumferential fluid path and the axial fluid paths are formed on a surface of the inner blade facing the outer surface of the piston.

6. The sealing member of claim 5, wherein the axial fluid paths are formed on an inner surface of the inner blade while being spaced part from each other.
